(19) United States
(12) Patent Application Publication
(10) Pub. No.: US 2004/0091411 A1
(43) Pub. Date: May 13, 2004

(54) High surface area, high porosity silica packing with narrow particle and pore diameter distribution and methods of making same

(76) Inventor: Bijan Modrek-Najafabadi, San Pedro, CA (US)

Correspondence Address: Varian Inc., Legal Department, 3120 Hansen Way D-102, Palo Alto, CA, 94304, US

(21) Appl. No.: 10/290,863

(22) Filed: Nov. 8, 2002

(51) Int. Cl. C01B 33/12

(52) U.S. Cl. 423/338; 423/335

(57) ABSTRACT

The present invention relates to LC packing materials in general, and silica-based HPLC packing materials in particular. Methods of forming and using the packing materials are also disclosed. The HPLC packing materials of the present invention feature high surface area and high porosity with good mechanical strength, due in part to the inclusion of a surfactant in the preparation of the LC packing materials. These desirable attributes are due, in part, to the narrow range of pore diameters that are generated in the preparation of the packing material.

### FIELD OF THE INVENTION

The present invention relates to liquid chromatography packing materials in general, and silica-based liquid chromatography packing materials in particular. More specifically, the present invention relates to the production of mesoporous high purity, high surface area silica spherical beads (2-9 μm average diameter) with high porosity and narrow pore size distribution suitable for use in liquid chromatography columns, such as high performance liquid chromatography columns, and other related techniques.

### Abbreviations

Abbreviations

| | |
|---|---|
| CMC | critical micelle concentration |
| HPLC | high performance liquid chromatography |
| LC | liquid chromatography |
| PEEK | poly(etheretherketone) |
| PEOS | polyethoxysilane |
| TEOS | tetraethylorthosilicate |
| TMOS | tetramethoxysilane |
| TPOS | tetrapropoxysilane |

### BACKGROUND OF THE INVENTION

The development of new, high purity liquid chromatography (LC) packing materials with superior separating ability, particularly high performance liquid chromatography (HPLC) packing materials, has been the subject of much research. Among the many different types of organic and inorganic packing materials, silica has received the most attention. A recent trend has focused on making silica packing materials with high surface area. As the surface area of the silica packing material increases, the average pore diameter concomitantly decreases. Normally, a decrease in pore diameter also is accompanied by a decrease in porosity. This decrease can contribute to a back pressure build up in HPLC columns packed with such material. Furthermore, a decrease in average pore diameter can also cause the inability to bond long ligands inside the pores of the packing material (e.g., 18 carbon chains (C₁₈), a bonded phase commonly employed in reversed phase HPLC). Additionally, it is noted that there is a compromise between very high porosity and mechanical strength; that is, very high porosity leads to lower mechanical strength, which can limit the use of the material as a packing material.

Together, these negative characteristics make such materials less suitable for use as an LC packing material in general and as a HPLC packing material in particular.

Consequently, efforts have been directed at developing an LC packing material comprising spherical silica particles (e.g., about 2 to about 9 μm in average diameter) with an average pore diameter ranging from about 90 to about 300 Å, a higher surface area (and thus a smaller decrease in pore diameter), a narrow pore diameter distribution, a higher porosity (and thus a smaller decrease in mechanical strength), that can withstand high pressure column packing. This goal has been elusive.

The present invention relates to the recent finding that surfactants can play a role in controlling, ordering, and monosizing the pore diameter of porous silica. This observation can be of assistance in the creation of silica beads having high surface area, high average pore diameter and good mechanical strength that are suitable for use as an HPLC packing material. For example, U.S. Pat. No. 5,858,457 to Brinker et al., U.S. Pat. No. 6,329,017 to Liu et al. and U.S. Pat. No. 6,365,266 to MacDougall et al. disclose production of surfactant-template silica films with well-ordered hexagonal and cubic pore structure and a pore diameter of up to 60 Å. Micelles, which are thought to be responsible for structurally ordering pores, are formed above a specific concentration of surfactants in a solvent. This concentration is called the critical micelle concentration (CMC). The type and concentration of the surfactant can influence the characteristics of the silica pores (see U.S. Pat. No. 5,308,602 to Calabro et al.), such as pore diameter, geometry and wall structure, by controlling micelle size.

Several inventors have attempted to take advantage of the observation that the presence and nature of a surfactant can influence pore formation in silica-comprising materials. For example, Gallis et al. employed mesoporous surfactant template spherical silica beads as an HPLC packing material (see U.S. Pat. No. 6,334,988). The silica of Gallis et al. has very high surface area, relatively high porosity (and/or pore volume), but has a small pore diameter. In fact, the largest pore diameter disclosed by Gallis et al. is 42 Å, with a 937 m²/g surface area and approximately a 0.62 ml/g pore volume.

This type of silica has at least the following shortcomings: first, silica with a 42 Å pore diameter is undesirable for long chain bonding ligands such as C₁₈, the most popular bonding ligand, as well as ligands comprising more than 18 carbons. More particularly, the chain length of these types of C₁₈ ligands is approximately 20 Å or more. Therefore, ligands of this length cannot efficiently penetrate the 42 Å pore and cover the entire surface area available. Next, this silica can also induce a higher backpressure, due to its small pore diameter. Further, only between 50% and 80% of this type of silica takes the form of spherical beads. This lack of spherical character can be problematic for packing some LC columns.

Another method for preparing spherical inorganic oxide-based material having monomodal particle size distribution is disclosed by Costa et al. in U.S. Pat. No. 5,304,364. The method of Costa et al. produced very small particles (only about 30 nm in diameter). Particles of this dimension are unsuitable for HPLC packing.

Bulducci et al. also describe a process for preparing porous spherical silica xerogels (see U.S. Pat. No. 6,103,209). Bulducci et al. employ emulsifying tubes with certain geometric characteristics, as disclosed in U.S. Pat. No. 4,469,648 to Ferraris et al. Spherical beads having an average particle size of about 10 to about 100 μm in diameter can be prepared by employing this method. Beads of this size are not useful as an HPLC packing material, however, due to their large particle size.

Thus, what is needed is a method of producing high surface area, high porosity silica packing with narrow particle and pore diameter distribution. Such a method would produce a silica product highly suitable for use as an LC packing, particularly as an HPLC packing, for example a silica bead with an average particle size of about 2 to about 9 μm, an average pore diameter of about 70 to about 300 Å, a high surface area, a narrow pore size distribution, a high porosity and good mechanical strength. What is also needed is an LC column, particularly an HPLC column, comprising such a material. The methods and compositions of the present invention solve these and other problems.

### SUMMARY OF THE INVENTION

A method of producing a mesoporous silica bead LC packing is disclosed. In one embodiment, the method comprises: (a) hydrolyzing, by acid-catalyzed hydrolysis, a compound comprising silicon to form a silica sol; (b) mixing the silica sol with a dispersive medium comprising one or more surfactants to form sol droplets; (c) transferring the sol droplets to a gelling medium at a linear velocity of about 3 m/s or greater to form a gelled product; (d) isolating the gelled product from any non-gelled material to form an isolated product; (e) calcinating the isolated product to form a mesoporous silica bead LC packing.

In one embodiment, the compound comprising silicon comprises an alkoxysilane. The hydrolysis can be catalyzed, for example, by an acid selected from the group consisting of organic acids, mineral acids, and combinations thereof. In another embodiment, the dispersive medium comprises an alcohol comprising about 8 or more carbon atoms. The one or more surfactants can be selected, for example, from the group consisting of polyoxyethylene sorbitans, polyoxythylene ethers, tri-block copolymers, alkyltrimethylammonium, surfactants comprising an octylphenol polymerized with ethylene oxide, and combinations thereof. In another embodiment, the transferring comprises employing an apparatus selected from the group consisting of an emulsion tubing and a nozzle, and the transferring can be followed by mixing the gelling medium and the transferred sol droplets.

The gelling medium can comprise a dispersive medium, a surfactant and a base, wherein the dispersive medium can comprise an alcohol comprising about 8 or more carbon atoms, the surfactant can be selected from the group consisting of polyoxyethylene sorbitans, polyoxythylene ethers, tri-block copolymers, alkyltrimethylammonium, surfactants comprising an octylphenol polymerized with ethylene oxide, and combinations thereof, and the base can comprise one or more organic bases. In other embodiments of the method, the isolating can comprise employing a technique selected from the group consisting of filtration, centrifugation and decanting.

The silica sol can be formed, for example, by mixing water at pH about 0.7 to about 2.0, with TEOS, and the sol droplets can be formed by: (a) mixing the silica sol with a dispersive medium comprising about 0.5% surfactant; and (b) stirring the medium at a desired speed. In another embodiment, the isolating comprises: (a) isolating the gelled product from any non-gelled material by employing a technique selected from the group consisting of filtration, centrifugation and decanting to form an isolated product; and (b) washing the isolated product with a compound selected from the group consisting of alcohols, water and organic solvents. In yet another embodiment, the calcinating comprises: (a) placing the isolated product in a vacuum oven for a desired period of time at ambient temperature; (b) vacuum drying the isolated product for a desired period of time at a desired temperature; (c) placing the isolated product in a furnace at ambient temperature; (d) incrementally increasing the temperature over about 24 hours to a desired temperature; and (e) baking the isolated gel at the desired temperature for a desired period of time.

In one embodiment, the method further comprises: (a) following calcinating, adding water to the mesoporous LC packing and boiling it with stirring for a desired period of time to form a hydrated product; (b) separating the hydrated product from the water by filtration to form a isolated hydrated product; and (c) drying the isolated hydrated product at a desired temperature for a desired period of time. Optionally, the method can further comprise aging the gelled product for a desired period of time at a desired temperature before isolating the gelled product.

An LC column is also disclosed. In one embodiment, the LC column comprises: (a) a durable support; and (b) a mesoporous silica bead LC packing, formed by a method disclosed herein, in contact with the durable support. In other embodiments, the durable support is a tube having an inner diameter of between about 1 mm and about 50 mm and can be formed from a material selected from the group consisting of stainless steel and PEEK.

Additionally, a mesoporous silica bead LC packing produced by a method of the present invention is disclosed. In some embodiments, the packing comprises a surface area of greater than about 450 m²/g and an average pore diameter of about 100 Å. The packing can have a pore size of between about 60 to about 300 Å and wherein the pores can have a uniform pore size. The packing can have a pore volume of greater than about 1.2 ml/g or greater and a pore half-width distribution of about 65 Å or less. The packing can also have a characteristic dimension of about 2 to about 9 μm. In another embodiment, the product of average pore diameter value (in Angstroms) multiplied by the pore volume value (in ml/g) multiplied by the surface area value (in m²/g) of the packing is greater than about 55000.

### BRIEF DESCRIPTION OF THE DRAWINGS

FIG. 1 is schematic depicting a reactor system that can be employed in the preparation of a mesoporous silica bead LC packing of the present invention.

FIG. 2A is plot depicting the pore diameter size distribution of a silica matrix produced by Daiso Co., Ltd. of Osaka, Japan.

FIG. 2B is a plot depicting the pore diameter size distribution of a silica matrix produced by Nomura Chemical Co., Ltd of Seto, Japan.

FIG. 2C is a plot depicting the pore diameter size distribution of a mesoporous silica bead LC packing of the present invention.

FIG. 3 is a typical batch particle size distribution of a mesoporous silica bead LC packing of the present invention.

### DETAILED DESCRIPTION OF THE INVENTION

I. Definitions

Following long-standing patent law convention, the terms “a” and “an” mean “one or more” when used in this application, including the claims.

As used herein, the term “about,” when referring to a value or to an amount of mass, weight, time, volume, concentration or percentage is meant to encompass variations of ±20% or ±10%, more preferably ±5%, even more preferably ±1%, and still more preferably ±0.1% from the specified amount, as such variations are appropriate.

As used herein, the term “analyte” means any molecule of interest. An analyte can comprise any polarity, although in the context of the present invention, non-polar moderately polar to highly polar molecules are of particular interest. An analyte can be disposed in a sample, and can form a component thereof. For example, a candidate therapeutic compound or metabolic byproducts thereof, can be an analyte, and the analyte can be disposed in, for example, a blood plasma sample, saliva, urine, drinking water, and water known or suspected to be polluted. Summarily, an analyte can comprise any molecule of interest.

As used herein, the term “associated” means contact between two or more entities, for example chemical entities. An association can be via a covalent bond or a non-covalent bond (e.g., hydrophobic interaction, hydrogen bonding, ionic interactions, van der Waals' forces and dipole-dipole interactions). An association can exist between two or more molecules, or between two or more different forms of matter, e.g., a liquid and a solid or a liquid and a gel.

As used herein, the term “durable”, when describing a support, means that the support is able to withstand regular exposure to pressures of about 10,000 psi. Examples of durable materials include stainless steel and poly(etheretherketone) (PEEK).

As used herein, the terms “liquid chromatography” and “LC” are used interchangeably and mean all forms of chromatography employing a mobile phase and a stationary phase. The terms specifically encompass, but are not limited to, HPLC.

As used herein, the term “mesoporous” means having a pore diameter of between about 70 and about 500 Å.

As used herein, the term “sol” means a colloidal solution comprising a suspension of particles that have a characteristic dimension (e.g., diameter, width, thickness or the like) that is intermediate between the same characteristic dimension of molecules of a solution and the same characteristic dimension of particles in a suspension. In one embodiment, a sol comprises a silica sol.

As used herein, the term “surfactant” means any molecule or composition that has the effect of lowering the surface tension of a liquid in which the surfactant is disposed. A “nonionic surfactant” is a surfactant that neither comprises positively nor negatively charged functional groups.

As used herein, the term “support” means a non-porous water insoluble material. A support can have any one of a number of configurations or shapes, such as a column, strip, plate, disk, rod, and the like. A support or supporting format can be hydrophobic, hydrophilic or capable of being rendered hydrophobic or hydrophilic, and can comprise synthetic or modified naturally occurring polymers, such as PEEK, nitrocellulose, cellulose acetate, poly (vinyl chloride), polyacrylamide, polyacrylate, polyethylene, polypropylene, poly(4-methylbutene), polystyrene, polymethacrylate, poly(ethylene terephthalate), nylon, poly(vinyl butyrate), polytetrafluoroethylene, etc., either used by themselves or in conjunction with other materials; metals (e.g., stainless steel), and the like (see, e.g., Buchmeiser, (2001) J. Chromatog. A 918:233-266).

II. A Mesoporous Silica Bead LC Packing of the Present Invention

A mesoporous silica bead LC packing of the present invention features a number of properties that make it desirable for use as an LC packing in general, and an HPLC packing in particular. A representative, but non-limiting, discussion of some of these properties follows.

In one aspect, a mesoporous silica bead LC packing of the present invention features a high surface area. LC packings that exhibit high surface areas can affect, and oftentimes enhance, LC separations. Thus, it is desirable for an LC packing to have a high surface area. In one embodiment, a mesoporous silica bead LC packing of the present invention exhibits a surface area of greater than about 500 m²/g. This surface area is greater than other commercially available packings (see, e.g., Table 1 and Table 2 hereinbelow), and contributes to the superior separation properties of the mesoporous silica bead LC packings of the present invention.

In another aspect, a mesoporous, high purity, high-surface area LC packing of the present invention has a pore size that balances surface area with ability to bond long chain moieties to a bead. As noted above, there is a trade-off between surface area available for functionalization and pore size. These properties are generally complementary to one another; as pore size increases, the surface area available for functionalization decreases. On one hand, if pore sizes are too small, the surface area available for functionalization decreases, since relatively large functionalizing ligands such as C₁₈-based moieties cannot penetrate the small pores, which can lead to a decrease in available surface area. On the other hand, pores that are too large can sacrifice the mechanical stability of the material and can also diminish surface area. The mesoporous silica bead LC packings of the present invention offer a balance between these two extremes. For example, in one embodiment, a mesoporous silica bead LC packing of the present invention comprises a pore diameter of between about 70 to about 300 Å, making the beads mesoporous, as that term is defined and employed by the IUPAC. These pore diameters are large enough to facilitate functionalization of the beads, while still maintaining a high degree of mechanical stability.

Additionally, the methods of preparing a mesoporous silica bead LC packing the present invention, as disclosed herein, results in beads having pores of a uniform pore size. This feature is particularly beneficial for the batch-to-batch reproducibility of preparations and ensures that the method repeatedly generates a uniform bead.

In another aspect of the present invention, mesoporous silica bead LC packing has a pore volume of greater than about 1.1 ml/g or greater and an average pore diameter of about 70 Å or greater. Again, such a pore volume and pore size ensures not only adequate mechanical stability, but also ensures that the mesoporous silica bead LC packing can be functionalized with any desired moiety, such as a C₁₈-based moiety. This ability lends flexibility to the range of applications in which a mesoporous silica bead LC packing of the present invention can be employed.

Continuing, a mesoporous silica bead LC packing of the present invention has a pore half-width distribution of about 65 Å or less. This relatively small pore half-width distribution is indicative of the uniformity and constancy of batch-to-batch preparation of a mesoporous silica bead LC packing of the present invention. This small variability ensures, for example, that subsequent functionalization procedures are efficient, predictable and offer high yields, due to the low pore half-width distribution.

Particle size can influence the packing of a material in a column, as well as the surface area of the particle. Particles that are smaller than this range (e.g., particles having diameters in the submicron range) are not suited for use as an LC packing, due in part to the closeness (small interparticle channels) with which packed particles are associated with one another. The more the particle size decreases, the tighter the interparticle channels become. These tight interparticle channels can lead to high backpressures. Additionally, high backpressures can limit the rate at which samples can be separated, and thus are unsuited for high throughput separation operations.

On the other hand, particles having a diameter larger than about 9 μm have large interparticle channels and do not give rise to high backpressures, but such particles also do not facilitate high resolution separations. This is due, in part, to the large interstitial channels present in a column packed with these large particles. As interstitial channel dimension increases, flow through the column increases as well, leaving less opportunity for analyte molecules to associate with the stationary phase and thereby cause peak broadening (see, e.g., Hanai, (1999) HPLC A Practical Guide, Royal Society of Chemistry, Cambridge, UK, pp. 102-108).

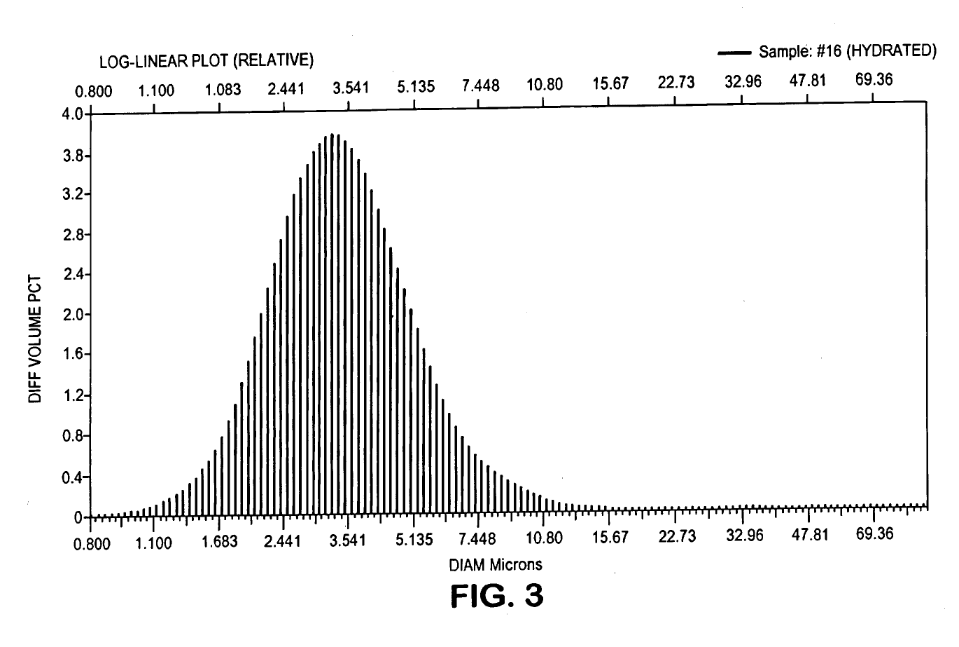

Thus, in one aspect, a mesoporous silica bead LC packing of the present invention has a characteristic dimension (e.g., diameter) of about 2 to about 9 μm. Such a size range is particularly desirable for LC packings because particles in this size range can facilitate desired packing properties and high resolution separations, while avoiding high backpressures. Particles having a characteristic dimension (e.g., diameter) of between about 2 μm and 9 μm can be reproducibly formed by the methods of the present invention. Referring to FIG. 3, this figure shows a typical batch particle size distribution achievable by employing the methods of the present invention. The median diameter of the particles of the batch described is about 3.23 μm.

III. Method of Forming a Mesoporous Silica Bead LC Packing of the Present Invention

The following sections describe aspects of preparing a mesoporous silica bead LC packing of the present invention. In one section, the chemical synthesis of the packing is described. In another section, apparatus suitable for preparing the packing is described.

III.A. Synthetic Method

In one aspect of the present invention, a method of producing a mesoporous silica bead LC packing is disclosed. In one embodiment, the method comprises hydrolyzing, by acid-catalyzed hydrolysis, a compound comprising silicon to form a silica sol. Various compounds comprising silicon can be employed, such as tetraalkyloxysilanes, trialkyloxysilanes, and combinations thereof. For example, compounds such as TEOS (Si(OCH₂CH₃)₄), TMOS, TPOS, PEOS, and combinations thereof can be employed. Such compounds are commercially available, for example from Gelest, Inc. of Tullytown, Pa., USA.

Techniques for acid-catalyzed hydrolysis of silicon-based compounds are known in the art and can be employed in the present invention. For example, when TEOS is employed as a compound comprising silicon, acid-catalyzed hydrolysis can be carried out by mixing the TEOS with water adjusted to an acidic pH, e.g., pH 0.7-2.0, with an acid, such as p-toluenesulfonic acid (p-TSA) (see, e.g., Coltrain et al., (1992) Ultrastructure of Advanced Materials (Uhlmann & Ulrich, eds), Wiley, New York, pp. 69-76). The mixture can be stirred until a clear phase appears, which will comprise a sol. Optionally, the silica sol can be aged following hydrolysis for a desired period of time at a desired temperature.

Continuing with the present embodiment, the silica sol can then be mixed with a dispersive medium comprising one or more surfactants to form sol droplets. For example, the silica sol can be mixed with a dispersive medium comprising about 0.5% surfactant; and the mixture stirred at a desired speed. Mixing can be achieved by employing any mixing device. When an electric mixer is employed (e.g., a homogenization mixer), the mixer can be operated at about 400 RPM, which will give adequate mixing of the components of the sol-dispersive medium composition, and can facilitate the formation of sol droplets.

One or more surfactants can be employed in a dispersive medium. A non-limiting list of some representative surfactants includes polyethylene-block-poly(ethylene glycol), polyoxyethylene sorbitans, polyoxythylene ethers, tri-block copolymers, alkyltrimethylammonium, surfactants comprising an octylphenol polymerized with ethylene oxide (e.g., Triton® X-100, available from JT Baker of Phillipsburg, N.J.), and combinations thereof. One or more non-ionic surfactants can be employed in a dispersive medium and can reduce the potential for contamination by alkali metals and halides that can sometimes be associated with ionic surfactants.

A dispersive medium can generally comprise any liquid that is immiscible with the silica sol mixture. Additionally, a dispersive medium that hydrogen bonds to silanol on the surface of the dispersed droplet can be employed. Such a dispersive medium can form a steric barrier. This steric barrier, which can be formed by dispersive enciclement of the droplets, can inhibit coagulation of particles formed during the method. Thus, in one example, a dispersive medium can comprise an alcohol with a high number of carbons, such as octanol, nonanol, decanol, undecanol, dodecanol and alcohols comprising more than 12 carbons. Combinations of such alcohols, or a mixture comprising such alcohols and an organic solvent, can also be employed.

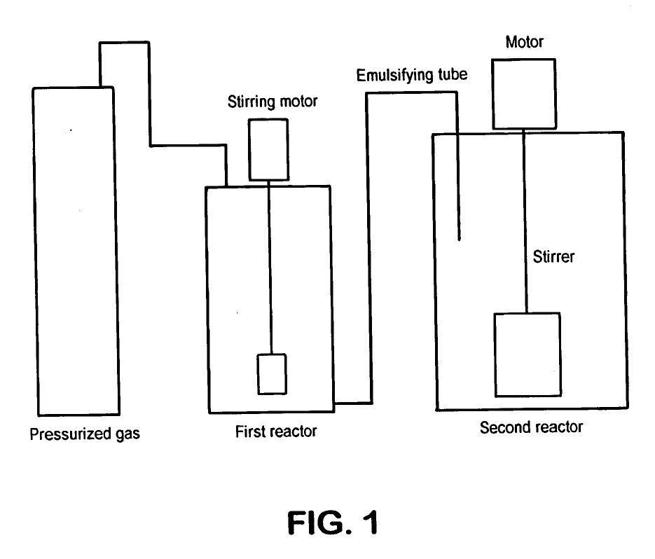

The sol droplets are then transferred to a gelling medium at a linear velocity of about 3 m/s or greater, to form a gelled product. Sol droplets can be transferred by employing any convenient apparatus, such as via an emulsion tubing or a nozzle. In one particular example, transfer can be achieved by employing an emulsion tubing, for example a 5 mm inner diameter, 250 cm length of tubing. Referring to FIG. 1, the transfer can be accomplished by pressurizing the first (i.e., dispersive) reactor with gas from a pressurized gas reservoir. Alternatively, transfer of the sol droplets from the first reactor to the second reactor can be achieved by employing a pump capable of fast displacement of the liquid. Transfer can be carried out at any rate, although a linear velocity of greater than about 3 m/sec (e.g., about 4-8 m/sec) can yield adequate results. Following transfer, the gelled product can be stirred at about 200 RPM for a desired period of time. This additional stirring can further facilitate the gelling process. Thus, the transferring can be followed by mixing the sol droplets and the gelling medium.

A gelling medium generally comprises a dispersive medium, a surfactant and a base that is miscible in the gelling medium. Representative dispersive media are described herein. A gelling medium preferably comprises a base, since sol droplets can be gelled by exposing the droplets to a base, a dispersive medium comprising a species such as an alcohol comprising a high number of carbons, and a surfactant or surfactant mixture (e.g., polyoxyethylene sorbitans, polyoxythylene ethers, tri-block copolymers, alkyltrimethylammonium, surfactants comprising an octylphenol polymerized with ethylene oxide (e.g., Triton® X-100), and combinations thereof). The inclusion of a surfactant in a dispersive medium and/or a gelling medium can be a factor in controlling the size and uniformity of a synthesized mesoporous silica bead LC packing formed by the methods of the present invention. Any basic species can be employed in a gelling medium, although generally, suitable bases are miscible in the dispersive medium. For example, any organic base (e.g., imidazole) can be employed in a gelling medium.

The gelled product can then be isolated from any non-gelled material in which the gelled product is disposed or with which the gelled product is associated (e.g., any non-volatized gelling medium). The separation of the gelled product from associated liquid can be performed by any of a variety of methods, such as filtration, centrifugation or decanting. When filtration is employed, such a filtration can comprise gravity-controlled filtration, or it can be assisted by application of a vacuum. Any suitable cartridge, disk or filter paper can be employed in the filtration.

Following isolation of the gelled product, the isolated product can be washed with a suitable wash solvent, such as water, an organic solvent or an alcohol. By performing the washing step, the purity of a packing produced by the methods of the present invention can be maintained or enhanced. Washing can be performed by passing a desired amount of the wash solvent over the isolated product.

The isolated gel can then be calcinated to form a mesoporous silica bead LC packing. The calcination can comprise two basic phases, drying and calcinating. Starting first with the drying phase, an isolated gel can be dried. In one embodiment, drying can be achieved by placing the washed gel in a vacuum oven and dried at ambient temperature for a desired period of time (e.g., about 12 hours). The isolated gel can optionally be further dried at a desired temperature above ambient temperature (e.g., about 170° C.) for a desired period of time. Upon cooling from the elevated temperature, the dried gel can be removed from the oven.

After removing the isolated gel from the vacuum oven, the isolated gel the second phase of calcination can be performed, namely calcinating (i.e., baking) the isolated product to form a mesoporous silica bead LC packing. This phase of the calcinating can be carried out by transferring the dried gel to a furnace, wherein it is calcinated at about 420-550° C. for a desired period of time, e.g., about 48 hours. In one embodiment of the method, after the dried gel is placed in the furnace, the temperature is raised gradually at a constant rate until it reaches a desired temperature. For example, the temperature can be raised by about 2° C. per minute and can be elevated to about 550° C. (see, e.g., Brinker & Scherer, (1990) Sol-Gel Science, Academic Press, p. 553).

Modifications of, and additions to, the above-described method can be made and are within the scope of the invention; such modifications and additions will be apparent to those of ordinary skill in the art upon consideration of the present disclosure. For example, the final product of the calcinating step (i.e., a mesoporous silica bead LC packing) can be further treated. In one embodiment of a further treatment, following the calcinating, water can be added to the calcinated silica and boiled with stirring for a desired period of time (e.g., about 24 hours). Subsequently, the silica can be removed from the water by filtration and dried at a desired temperature, e.g., about 75° C., for a desired period of time.

A sample of the final product can also be characterized to determine pore volume, average pore diameter, surface area, particle size distribution, mechanical strength, elemental composition and other properties. Such a characterization can be desirable when the methods of the present invention are employed on a large scale and quality control over the batches is desired.

In another variation on the recited method, after forming a gelled product, but prior to isolation of the gelled product, the gelled product can optionally be aged for a desired period of time at a desired temperature. In one aging protocol, the aging of the gelled product can be performed by incubating the gelled product undisturbed at ambient temperature for a given period of time, for example about 24 hours. Subsequently, the gelled product can be placed in an oven and incubated at a temperature greater than ambient temperature (e.g., about 50 to about 90° C.) for a desired period of time.

The temperature and length of time the gelled product is incubated at a temperature above ambient temperature (i.e., aged), if it is desired to perform an aging step, can influence the properties of the final product. For example, by increasing the time and/or temperature, the average pore diameter and/or pore volume of the final product can be varied and/or controlled.

III.B. Apparatus Suitable for Preparing a Mesoporous Silica Bead LC Packing of the Present Invention

A representative apparatus that can be employed in the preparation of a mesoporous silica bead LC packing of the present invention is disclosed in FIG. 1, which depicts a silica production reactor of the present invention. In the depicted embodiment, a first reactor communicates with a pressurized gas source. The pressurized gas can be employed in the transfer of the sol droplets from a first reactor to a second reactor, in which gelling and subsequent operations can be carried out. The transfer can be carried out at a linear velocity of about 3 m/sec or greater, for example about 4-8 m/sec. A pressurized gas can be employed in the transfer. Although any pressurized gas can be employed, if a chemically inert gas is selected the gas can be employed to pressurize the first reactor with the confidence that the gas will not affect the chemical composition of the sol droplets.

The first reactor can serve as a site for the formation of sol droplets and for carrying out steps prior to the formation of sol droplets. A stirrer driven by a stirring motor can be disposed in the first reactor. The stirrer can be an electric mixer, such as a homogenization mixer or a mixer driving a propeller blade. By associating a mixer with the first reactor, all steps up to and including sol droplet formation can be performed in the reactor, if desired. This can minimize any risk of contamination and can enhance the yield of the final product.

Continuing with the embodiment depicted in FIG. 1, a second reactor communicates with the first reactor via an emulsifying tube. The second reactor can serve as the site at which formation of a gelled product can be carried out. The second reactor can contain a gelling medium. In operation, the sol droplets are transferred to the second reactor via the emulsifying tube. When the first reactor is pressurized, the second reactor can be isolated from the first reactor. Upon reconnection of the second reactor to the first reactor (for example by opening a valve), the sol droplets can be transferred via the emulsifying tubing to the second reactor, which can contain a gelling medium. As the sol droplets contact the gelling medium, the gelling process is initiated.

A stirrer driven by a stirring motor is disposed in the second reactor. Again, such a stirrer can comprise a homogenizing mixer or an electric mixer fitted with a propeller blade, and the stirrer should be adapted to operate at a desired speed.

Thus, in the methods of the present invention, when preparing a mesoporous silica bead LC packing of the present invention, sol and sol droplet formation can be performed in the first reactor. Gel formation can be initiated in the second reactor and via transfer through the emulsifying tubing to the second reactor.

The remaining steps of the embodiment can be performed outside of the reactor arrangement depicted in FIG. 1. Such steps include aging the gelled product, which can be performed in an oven. Filtration can be performed as described herein and can employ a suitable cartridge, disk or filter paper. In some cases, any desired washing of the filtered product can be performed while the filtered product is disposed on the filtration cartridge, disk or filter paper. A dried gel can be calcinated (e.g., baked) in a furnace. In one example, a furnace can be adapted to increase the temperature of the furnace at a constant rate.

IV. An LC Column Comprising Mesoporous Silica Bead LC Packing of the Present Invention

The desirable characteristics of the mesoporous silica beads of the present invention, e.g., good mechanical strength, well-ordered, uniform pores of a desirable size, high porosity of surfactant template silica and desirable particle size, make these materials suitable for use as an LC column packing. The particle size of the mesoporous silica beads of the present invention (2-9 μm), make this material particularly desirable for use as a packing in an LC column (e.g., an HPLC column).

Thus, in one aspect of the present invention, an LC column is disclosed. In one embodiment, an LC column comprises a mesoporous silica bead LC packing formed by the methods described herein in contact with a durable support. Suitable supports include hollow tubes formed from a durable material, such as stainless steel or PEEK. Such supports can have an inner diameter of between about 1 mm and about 50 mm. Selection of a suitable inner diameter can sometimes depend on the use to which a formed column will be put, as well as the scale on which the column will be used (e.g., analytical, preparative or batch-sized scale). Methods of packing LC columns are generally known in the art. Thus, methods of packing a column with mesoporous silica beads formed by the methods of the present invention will be apparent to those of ordinary skill in the art upon consideration of the present disclosure.

### LABORATORY EXAMPLE

The following Laboratory Example has been included to illustrate preferred modes of the invention. Certain aspects of the following Laboratory Example are described in terms of techniques and procedures found or contemplated by the present inventor to work well in the practice of the invention. This Laboratory Example is exemplified through the use of standard laboratory practices of the inventor. In light of the present disclosure and the general level of skill in the art, those of skill will appreciate that the following Laboratory Example is intended to be exemplary only and that numerous changes, modifications and alterations can be employed without departing from the spirit and scope of the present invention.

### Laboratory Example 1

### Preparation and Characterization of a Mesoporous Silica Bead LC Packing of the Present Invention

A mesoporous silica bead LC packing was prepared and characterized. The preparation followed, stepwise, a protocol described broadly hereinabove. In one aspect of the characterization, the properties of the LC packing prepared were compared to several commercially available silica packings. Results and discussion of the characterization follow a description of the LC packing preparation.

1.1 Preparation of a Mesoporous Silica Bead LC Packing

1. 720 ml TEOS and 1000 ml high purity water (deionized water) at a pH adjusted to 1.8 by using p-toluinesulfonic acid (10 g/l) were mixed together.

2. The mixture of step 1 was moderately stirred for 30 minutes at a temperature of 20° C. in a reactor that can be pressurized to 100 psi (see FIG. 1).

3. 4000 ml decyl alcohol and 5 ml surfactant (3-part sorbitan monooleate and 1 part TWEEN 80® by volume) were then mixed together.

4. 2250 ml decyl alcohol, 90 g imidazole and 25 ml surfactant (3 parts sorbitan monooleate, one part TWEEN 80®) were then mixed together.

5. The mixture of step 3 was then added to the mixture of step 2 and the resulting mixture was stirred.

6. The mixture of step 3 was added to the mixture of step 2 after 50 minutes elapsed from the completion of step 2 and the resulting mixture was stirred for 10 minutes.

7. While stirring was continued, the mixture of step 6 was transferred into the mixture formed in step 4 via 5 mm internal diameter by 250 cm length tubing and the reactor was pressurized to 80 psi (linear velocity of transfer was 4.7 m/sec). Stirring was continued for 25 minutes.

8. After 24 hours had passed, the contents of step 7 were placed in an oven at 65° C. for 5 hours.

9. The formed gel was then separated from the liquid contents of the reactor by filtration and the resulting filtrate was washed with ethyl alcohol.

10. The filtered gel was dried in a vacuum oven at room temperature overnight.

11. The vacuum oven temperature was raised to 165° C. and left to cool down. The weight of silica at this stage was 216 g.

12. The silica was transferred to a furnace and gradually, over a period of 24 hours, the temperature was raised to 550° C. The silica was calcinated for 70 hours at this temperature.

13. 1 liter of HPLC water was added to the calcinated silica and was boiled with stirring for 24 hours.

14. The silica was separated from water by filtration.

15. The silica was then dried at 75° C.

1.2 Characterization of a Mesoporous Silica Bead LC Packing

The surface area, pore size diameter and pore volume of this batch were determined to be, respectively, 540 m²/g, 98 Å and 1.34 ml/g. After sizing the beads of this batch, it was determined that beads were formed in the following approximate proportions: 69% of the beads had an average diameter of 7 μm, 11% of the beads had a diameter of 10 μm and 20% of the beads had an average diameter of 14 μm.

1.3 LC Column Packing and Operation

After preparation and characterization, LC columns were packed with the packing described hereinabove. It was observed that high efficiency LC columns could be packed at 8000 psi packing pressure without any damage to the packing or to the column.

The operational properties of LC columns packed with this packing were also studied. LC columns packed with the described packing were seen to have low backpressure in operation.

A comparison of surface area, pore size, pore volume and pore diameter half-width distribution was also performed. The comparison involved the LC packing of the present invention described hereinabove, as well as two commercially available silica packings, namely, a silica packing that is commercially available from Daiso Co, Ltd of Osaka, Japan, and a silica packing that is commercially available from Nomura Chemical Co., Ltd of Seto, Japan. This comparison is presented in Table 1.

TABLE 1
Characteristic Comparison of an LC Packing of the Present
Invention With Some Commercially Available Packings

| | | Pore | Pore | |
|---|---|---|---|---|
| | Surface Area | Diameter | Volume | Half-width |
| Manufacturer | (m²/g) | (Å) | (ml/g) | Distribution (Å) |
| Diaso | 435 | 87 | 0.97 | ˜77 |
| Nomura | 439 | 97 | 1.15 | ˜147 |
| Present | 540 | 98 | 1.34 | ˜62 |
| Invention | | | | |

This comparative example demonstrates that an LC packing formed by the methods of the present invention features a larger surface area than other commercially available packings.

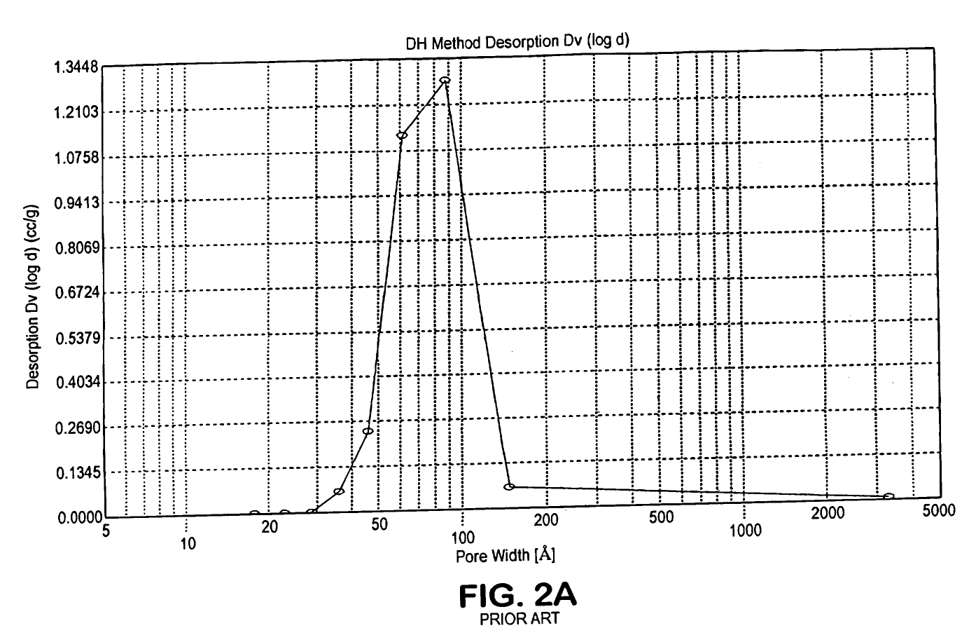

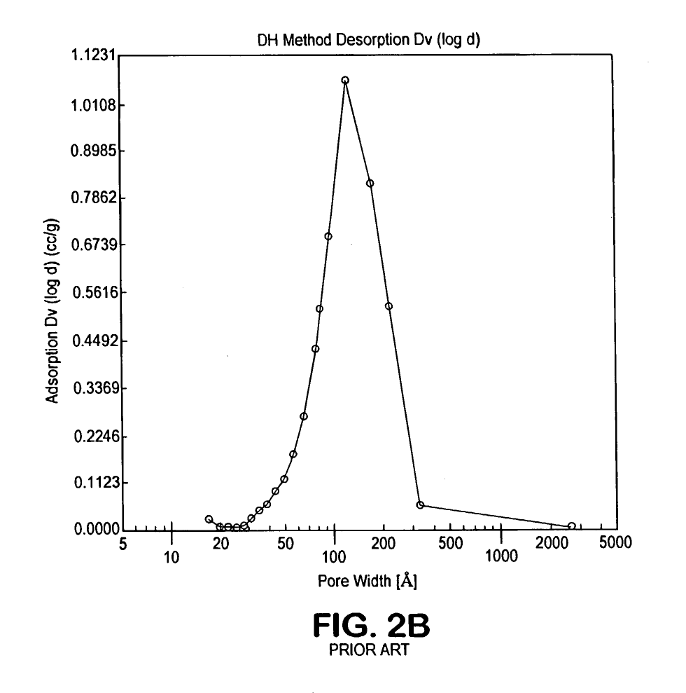

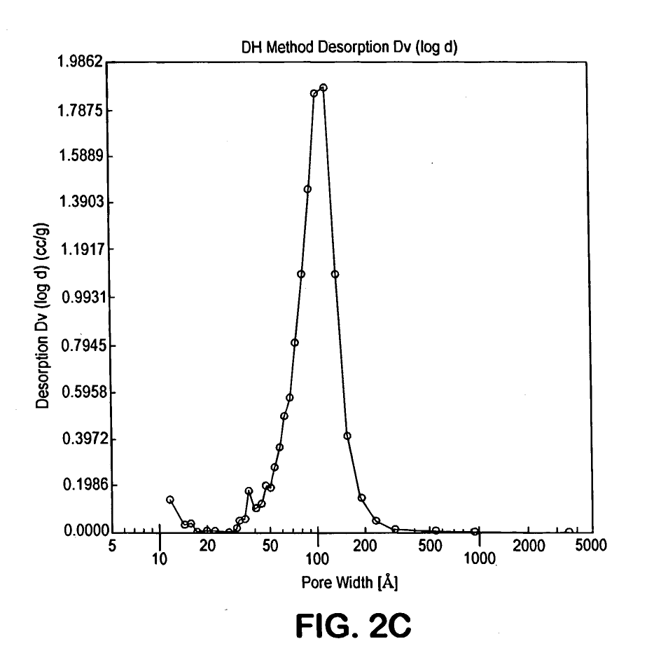

Additionally, an LC packing formed by the methods of the present invention has a larger pore volume that other commercially available packings. FIGS. 2A, 2B and 2C indicate the pore diameter of the Diaso silica, the Nomura silica and the mesoporous silica beads formed by the methods of the present invention, respectively. These figures indicate the average pore diameter to be about 87 for the Daiso silica, about 97 for the Nomura silica and about 98 for the silica of the present invention. Although at least one commercially available packing has a similar pore size (the Nomura packing), this packing has other drawbacks, such as a lower surface area.

It is noted that for nearly the same size average pore diameter of the present invention and the other two commercial packings, pore volume and surface area of the packing of the present invention has a higher value, which can be greatly beneficial. In fact, if the values of the surface area, average pore diameter and pore volume of each of these packings are multiplied, the result corresponds to the highest number for a packing of the present invention.

TABLE 2
Table of Pore Diameter Multiplied by Pore Volume and Surface
Area for Some Commercially Available Packings

| | Pore size | Pore volume | Surface area | |
|---|---|---|---|---|
| Manufacturer | (d, in Å) | (v, in ml/g) | (s, in m²/g) | d.v.s. Value |
| GL Sciences | 100 | 1.05 | 450 | 47250 |
| GL Sciences | 150 | 1.15 | 320 | 55200 |
| GL Sciences | 80 | 0.7 | 450 | 25200 |
| GL Sciences | 100 | 0.9 | 350 | 31500 |
| GL Sciences | 80 | 0.8 | 400 | 25600 |
| Daiso | 193 | 1.09 | 227 | 47754 |
| Daiso | 136 | 1.04 | 305 | 43139 |
| Daiso | 150 | 0.98 | 261 | 38367 |
| Daiso | 55 | 0.68 | 498 | 18625 |
| Daiso | 97 | 0.89 | 368 | 31769 |
| Daiso | 97 | 1.1 | 454 | 48442 |
| Daiso | 296 | 1.05 | 112 | 34810 |
| Nomura | 252 | 1.08 | 166 | 45179 |
| Nomura | 134 | 1.12 | 297 | 44574 |
| Nomura | 97 | 1.15 | 439 | 48970 |
| Dokai | 99 | 1.04 | 421 | 43346 |
| Kromasil | 100 | 0.92 | 311 | 28612 |
| Present Invention | 98 | 1.34 | 540 | 70913 |
| Present Invention | 131 | 1.47 | 448 | 86271 |

The d.v.s values of Table 2 (calculated by multiplying the pore size, the pore volume and the surface area of the material) demonstrate that the present invention has the highest d.v.s values (70913 and 86271) of all of the packings studied. Packings other than the embodiments of the present invention studied have a d.v.s value less than 55000. Additionally, the pore volume of these commercially available packings is less than 1.2 ml/g.

It will be understood that various details of the invention may be changed without departing from the scope of the invention. Furthermore, the foregoing description is for the purpose of illustration only, and not for the purpose of limitation.

What is claimed is:

1. A method of producing a mesoporous silica bead LC packing, the method comprising:
(a) hydrolyzing, by acid-catalyzed hydrolysis, a compound comprising silicon to form a silica sol;
(b) mixing the silica sol with a dispersive medium comprising one or more surfactants to form sol droplets;
(c) transferring the sol droplets to a gelling medium at a linear velocity of about 3 m/s or greater to form a gelled product;
(d) isolating the gelled product from any non-gelled material to form an isolated product; and
(e) calcinating the isolated product to form a mesoporous silica bead LC packing.

2. The method of claim 1, wherein the compound comprising silicon comprises an alkoxysilane.

3. The method of claim 1, wherein the hydrolysis is catalyzed by an acid selected from the group consisting of organic acids, mineral acids, and combinations thereof.

4. The method of claim 1, wherein the dispersive medium comprises an alcohol comprising about 8 or more carbon atoms.

5. The method of claim 1, wherein the one or more surfactants is selected from the group consisting of polyoxyethylene sorbitans, polyoxythylene ethers, tri-block copolymers, alkyltrimethylammonium, surfactants comprising an octylphenol polymerized with ethylene oxide, and combinations thereof.

6. The method of claim 1, wherein the transferring comprises employing an apparatus selected from the group consisting of an emulsion tubing and a nozzle.

7. The method of claim 1, wherein the transferring is followed by mixing the gelling medium and the transferred sol droplets.

8. The method of claim 1, wherein the gelling medium comprises a dispersive medium, a surfactant and a base.

9. The method of claim 8, wherein the dispersive medium comprises an alcohol comprising about 8 or more carbon atoms.

10. The method of claim 8, wherein the surfactant is selected from the group consisting of polyoxyethylene sorbitans, polyoxythylene ethers, tri-block copolymers, alkyltrimethylammonium, surfactants comprising an octylphenol polymerized with ethylene oxide, and combinations thereof.

11. The method of claim 8, wherein the base comprises one or more organic bases.

12. The method of claim 1, wherein the isolating comprises employing a technique selected from the group consisting of filtration, centrifugation and decanting.

13. The method of claim 1, wherein the silica sol is formed by mixing water at pH about 0.7 to about 2.0, with TEOS.

14. The method of claim 1, wherein the sol droplets are formed by:
(a) mixing the silica sol with the dispersive medium comprising about 0.5% surfactant; and
(b) stirring the dispersive medium at a desired speed.

15. The method of claim 1, wherein the isolating comprises:
(a) isolating the gelled product from any non-gelled material by employing a technique selected from the group consisting of filtration, centrifugation and decanting to form an isolated product; and
(b) washing the isolated product with a compound selected from the group consisting of alcohols, water and organic solvents.

16. The method of claim 1, wherein the calcinating comprises:
(a) placing the isolated product in a vacuum oven for a desired period of time at ambient temperature;
(b) vacuum drying the isolated product for a desired period of time at a first desired temperature;
(c) placing the isolated product in a furnace at ambient temperature;
(d) incrementally increasing the temperature over about 24 hours to a second desired temperature; and
(e) baking the isolated gel at the second desired temperature for a desired period of time.

17. The method of claim 1, further comprising:
(a) following calcinating, adding water to the mesoporous LC packing and boiling it with stirring for a desired period of time to form a hydrated product;
(b) separating the hydrated product from the water by filtration to form a isolated hydrated product; and
(c) drying the isolated hydrated product at a desired temperature for a desired period of time.

18. The method of claim 1, further comprising aging the gelled product for a desired period of time at a desired temperature before isolating the gelled product.

19. An LC column comprising:
(a) a durable support; and
(a) a mesoporous silica bead LC packing formed by the method of claim 1 in contact with the durable support.

20. The LC column of claim 19, wherein the support comprises a tube having an inner diameter of between about 1 mm and about 50 mm.

21. The LC column of claim 19, wherein the durable support is formed from a material selected from the group consisting of stainless steel and PEEK.

22. A mesoporous silica bead LC packing produced by the method of claim 1.

23. The mesoporous silica bead LC packing of claim 22, wherein the packing comprises a surface area of greater than about 450 m²/g and an average pore diameter of about 100 Å.

24. The mesoporous silica bead LC packing of claim 22, wherein the mesoporous silica bead LC packing has an average pore size of between about 60 to about 300 Å.

25. The mesoporous silica bead LC packing of claim 22, wherein the pores have a uniform pore size.

26. The mesoporous silica bead LC packing of claim 22, wherein the mesoporous silica bead LC packing has a pore volume of greater than about 1.2 ml/g or greater.

27. The mesoporous silica bead LC packing of claim 22, wherein the mesoporous silica bead LC packing has a characteristic dimension of about 2 to about 9 μm.

28. The mesoporous silica bead LC packing of claim 22, wherein the product of average pore diameter value (in Angstroms) multiplied by the pore volume value (in ml/g) multiplied by the surface area value (in m²/g) of the packing is greater than about 55000.
